(19) United States
(12) Patent Application Publication
(10) Pub. No.: US 2002/0061508 A1
(43) Pub. Date: May 23, 2002

(54) Magnetic coloring kit

(76) Inventor: Phila P. Vocia, Atlantic City, NJ (US)

Correspondence Address: Ourmazd S. Ojan, Paul & Paul, 2900 Two Thousand Market Street, Philadelphia, PA, 19103, US

(21) Appl. No.: 09/825,209

(22) Filed: Oct. 29, 2001

Related U.S. Application Data
(60) Provisional application No. 60/200,243, filed on Apr. 28, 2000.

(51) Int. Cl. B43L 1/00

(52) U.S. Cl. 434/409

(57) ABSTRACT

An apparatus for a coloring and activity game and a method of using the apparatus are disclosed. The apparatus is in the form of a kit that includes a set of background sheets, that can be drawn on, colored, or painted by a child, a set of magnetic characters, and a set of magnetic captions that can contain words of description, thoughts or speech attributable to the characters. The sheets can be placed over a magnetically attractive background to which the characters and captions are magnetically attracted. The characters and captions can then be arranged over the sheets in various ways by the child to represent and/or play out various scenarios imagined by or provided to the child. The background sheets may be made of plain paper, or the background sheets may be transparent, washable or both.

### BACKGROUND OF THE INVENTION

1. Field of Invention

This invention relates generally to a game apparatus and a method for using the game apparatus.

2. Brief Description of the Related Art

Coloring books having preprinted outlines that are colored in using crayons are well known in the art. However, these coloring books limit the subject of the drawing to what is presented by the preprinted outline and once the outlines are colored in the user's, usually children, lose interest in the colored-in outline and set it aside. Furthermore, each page in a traditional coloring book can be used only once and after it is colored in it loses its value as an activity that can occupy a child. The need persists in the art for a coloring game that continues to serve as an activity game for children even after the coloring portion of the game is completed.

### SUMMARY OF THE INVENTION

The present invention is directed to an apparatus for a coloring and activity game and a method of using the apparatus. The coloring and activity game apparatus is in the form of a kit that includes a set of background sheets, that can be drawn on, colored, or painted by a child, a set of magnetic characters, and a set of magnetic captions that can contain words of description, thoughts or speech attributed to the characters. The sheets can be placed over a magnetically attractive background to which the characters and captions are magnetically attracted. The characters and captions can then be arranged over the sheets in various ways by the child to represent and/or play out various scenarios imagined by or provided to the child. The background sheets may be made of plain paper, or the background sheets may be transparent, washable or both. Some or all the sheets may have preprinted outlines of scenery that can be colored by the child and over which the characters can be placed to act out various scenarios.

### BRIEF DESCRIPTION OF THE DRAWINGS

FIGS. 1-7, show various background sheets having various background scenes that can be colored in by a user.

FIGS 8-29, are views showing the various cartoon character magnets and a preprinted caption magnet indicating the positive trait associated with each character.

FIG. 30, shows a caption magnet for conveying text indicative of the characters thoughts.

FIG. 31, shows a caption magnet for conveying descriptive text.

FIG. 32, shows a background sheet placed over the backboard supplied with the present invention.

FIG. 33, shows a comer magnet for use with the present invention.

Like reference numerals indicate like elements throughout the several views.

### DETAILED DESCRIPTION OF THE INVENTION

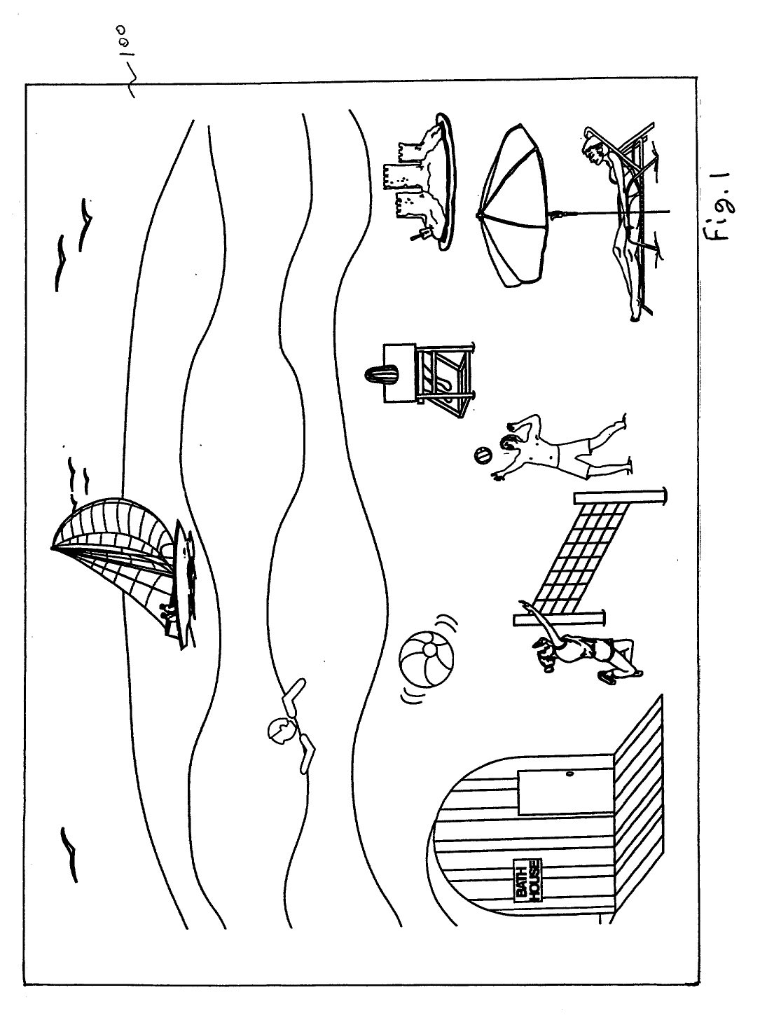

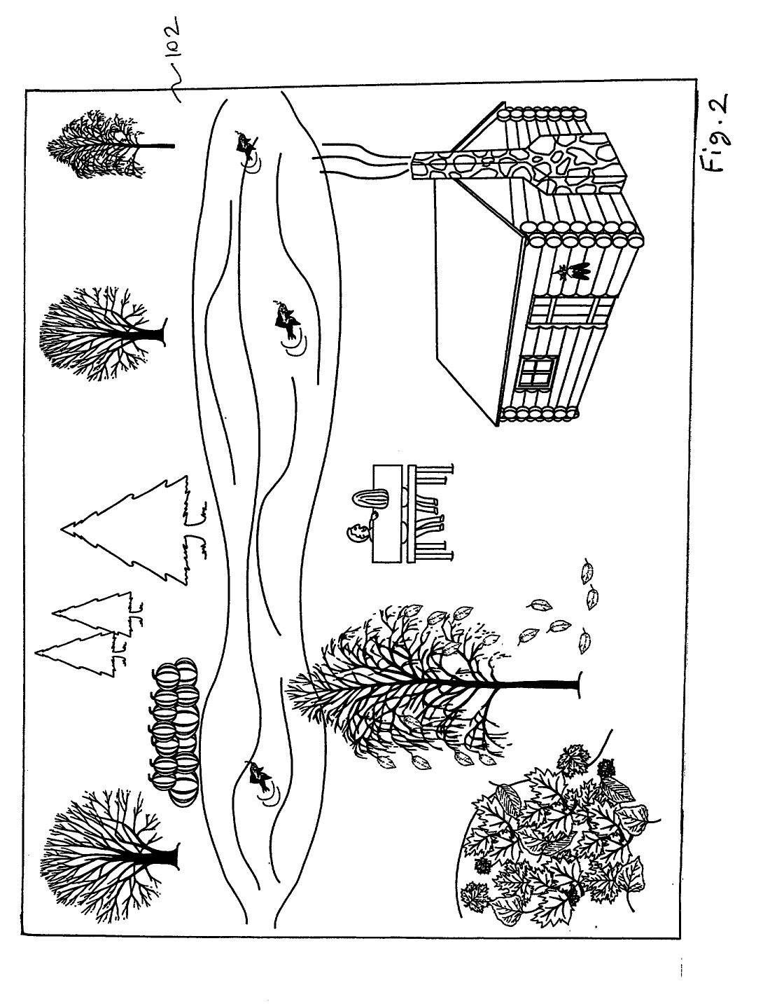

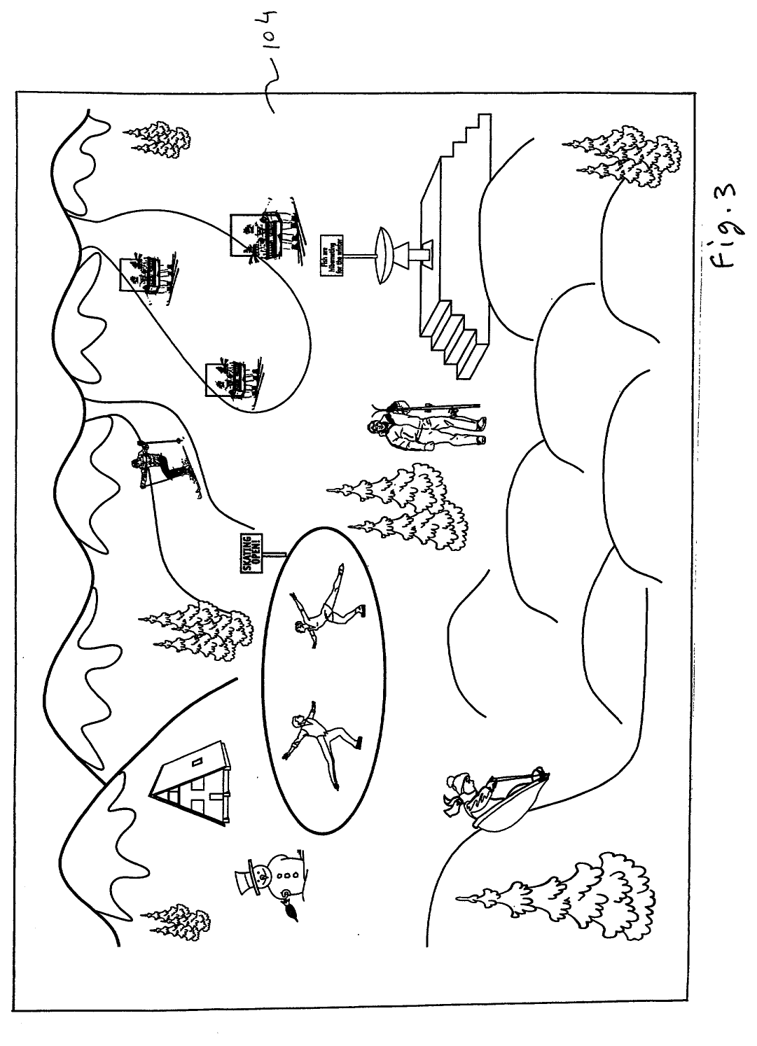

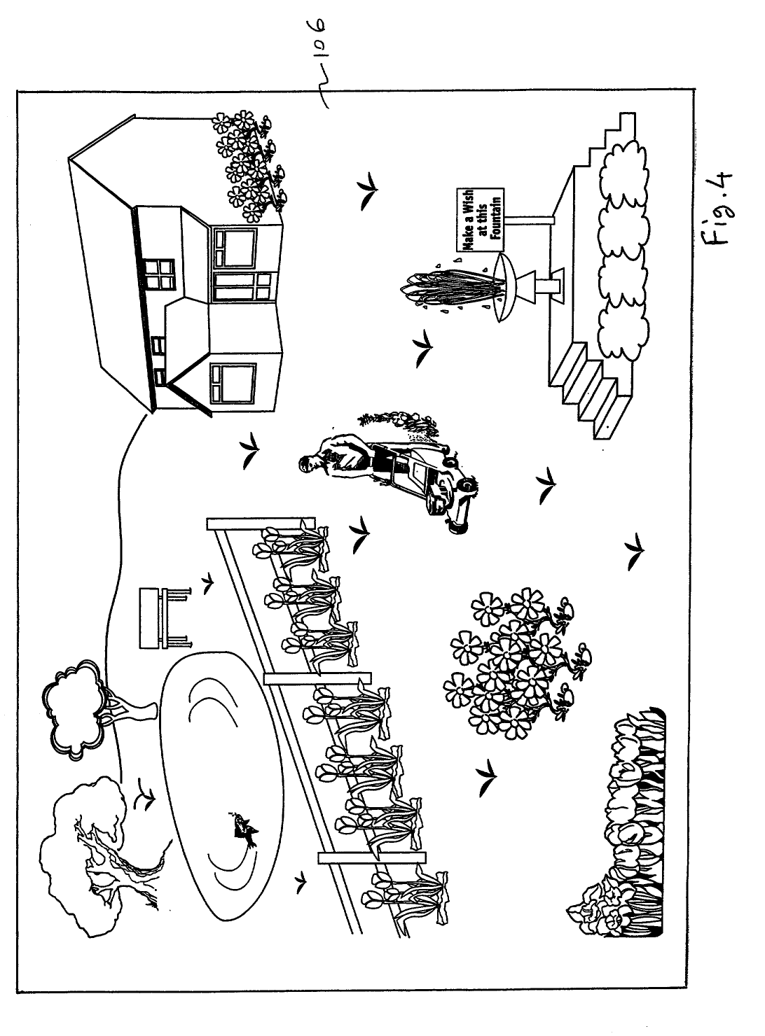

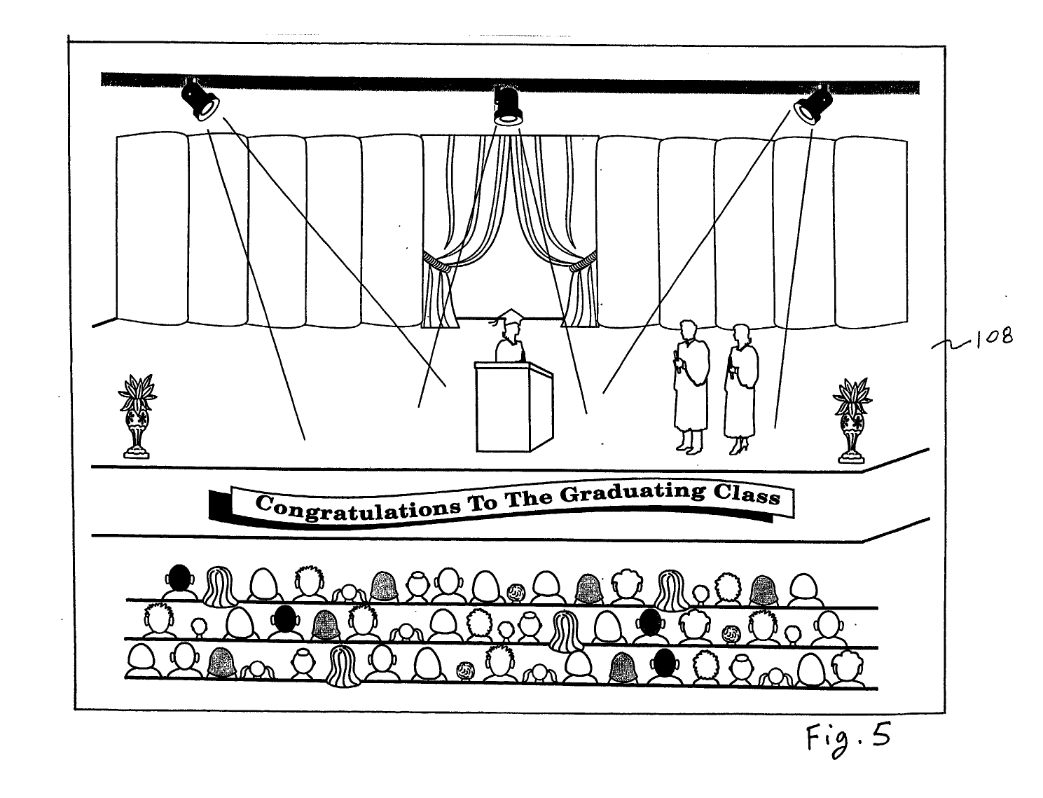

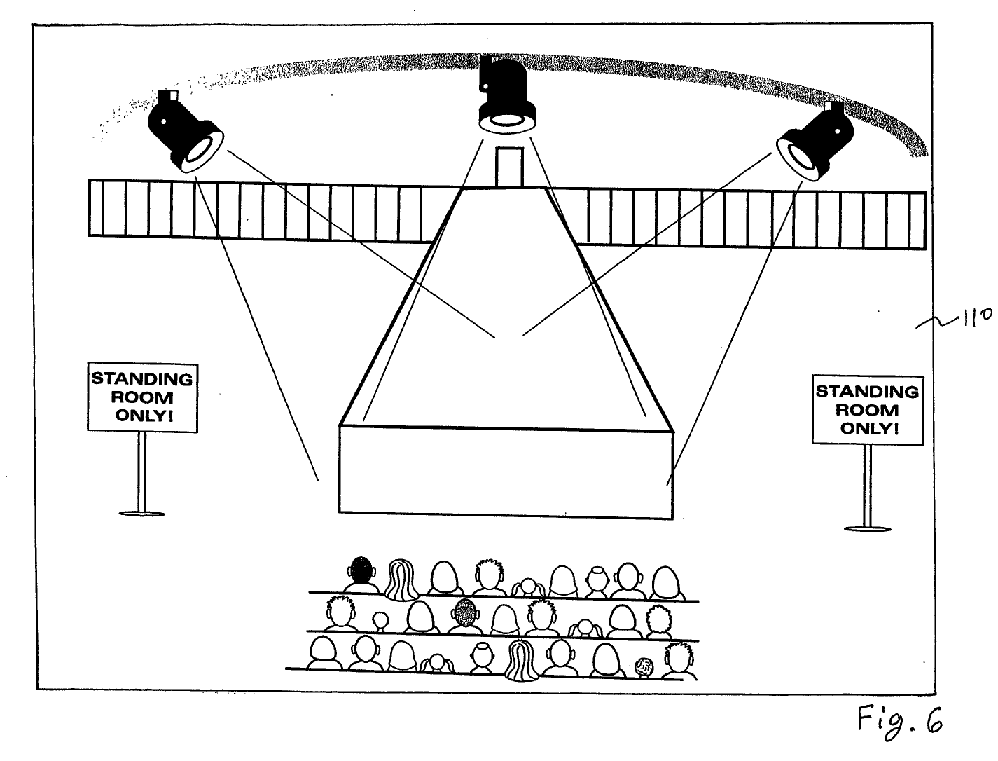

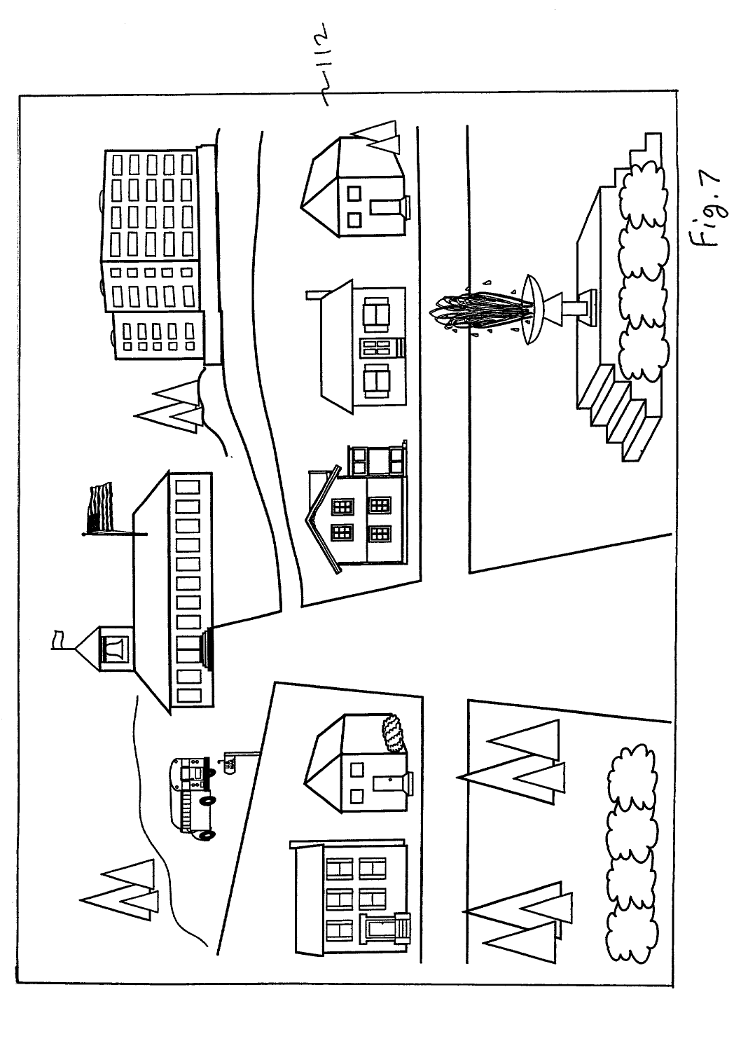

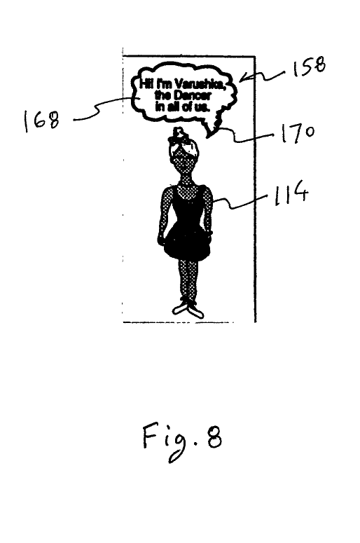

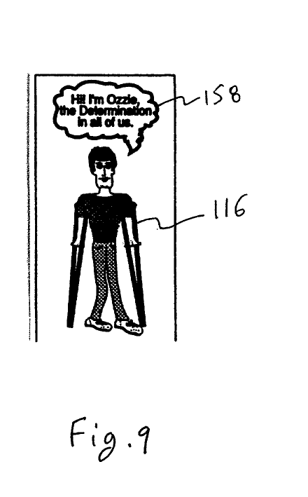

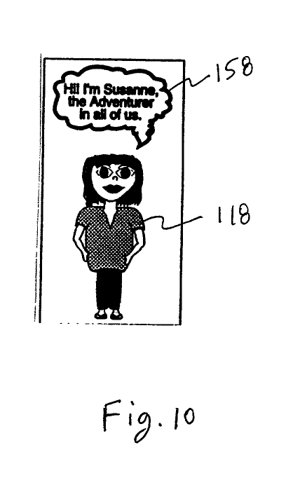

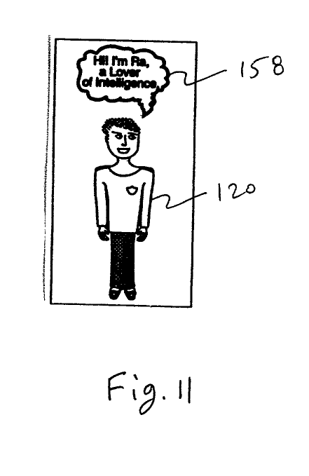

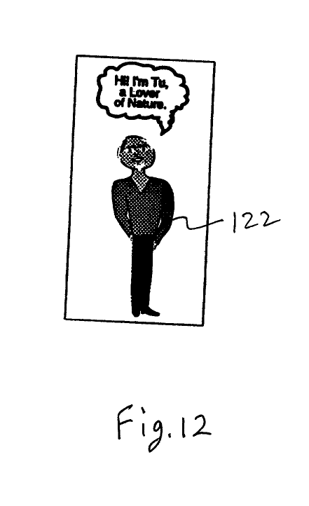

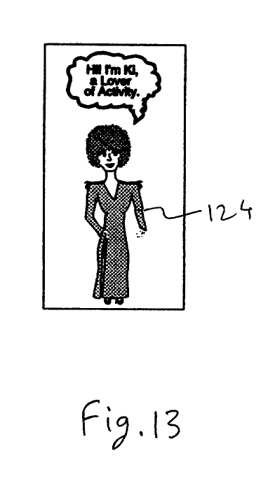

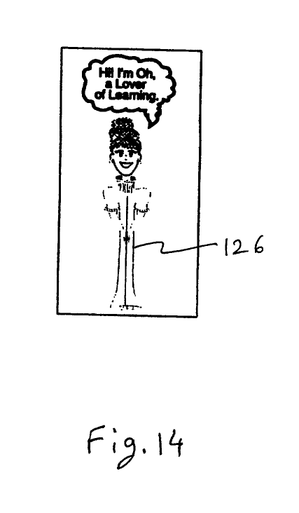

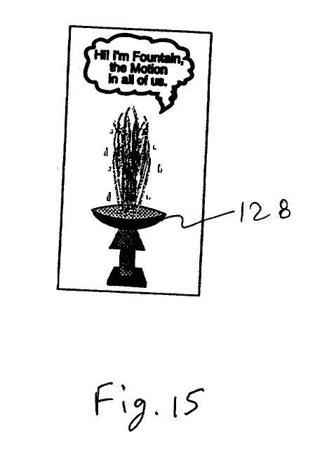

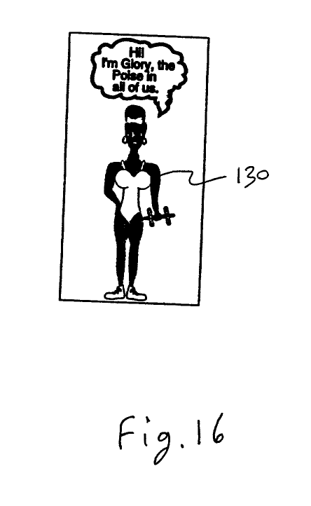

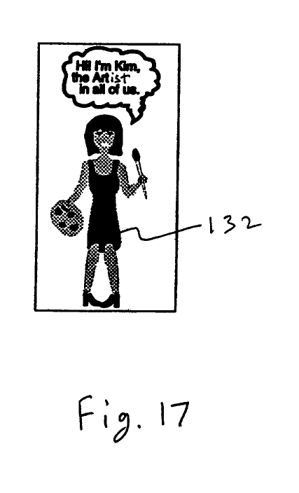

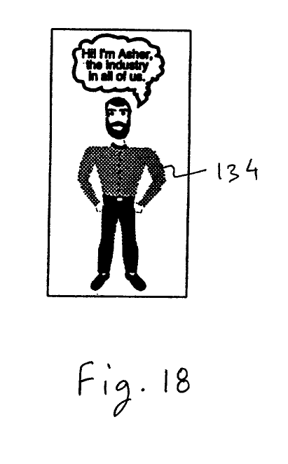

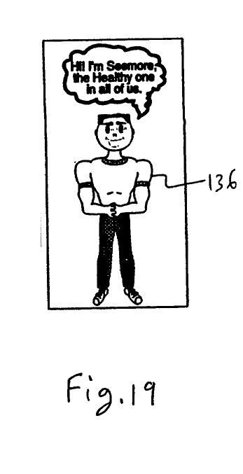

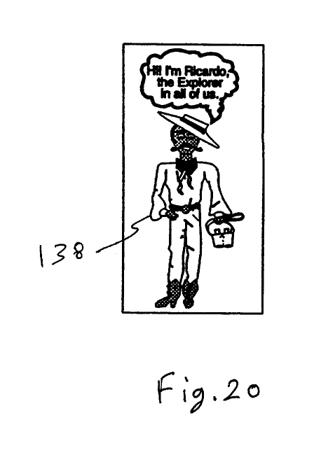

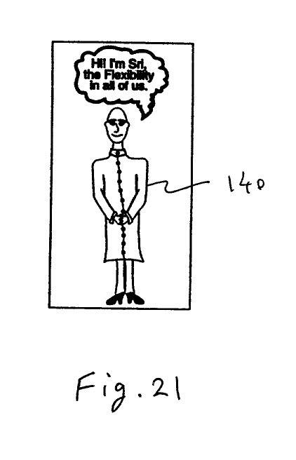

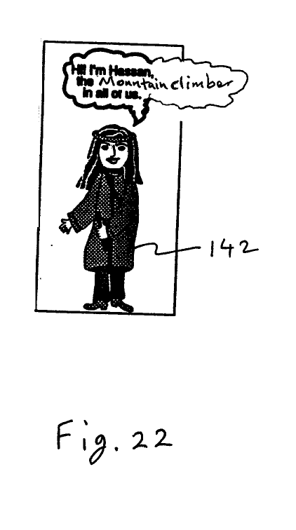

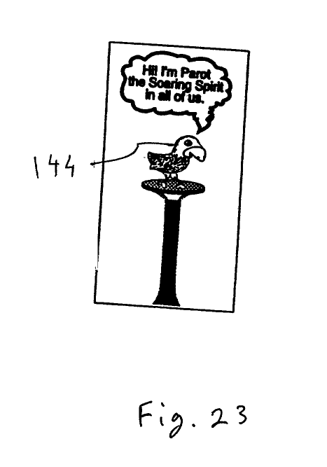

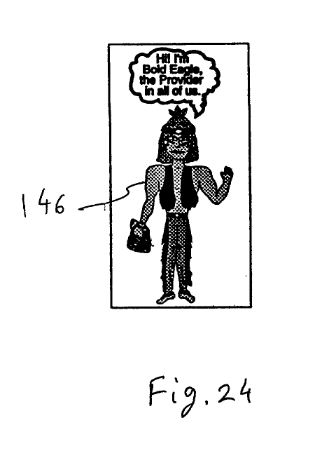

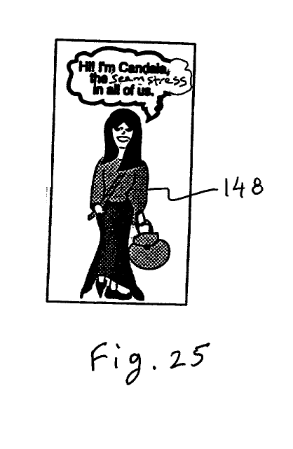

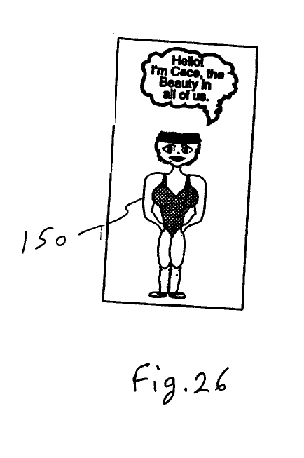

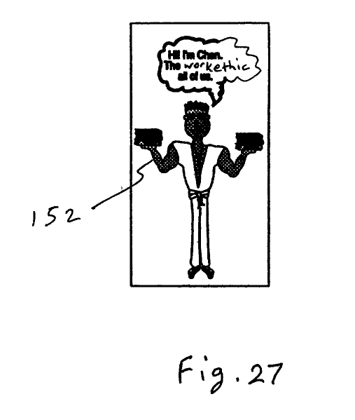

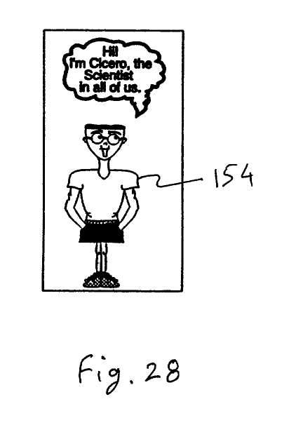

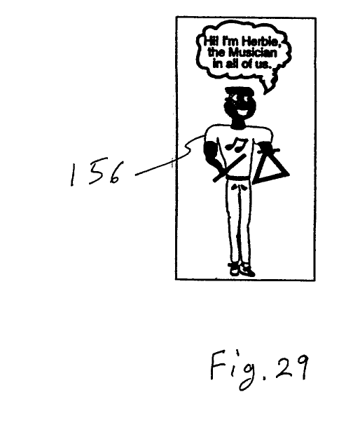

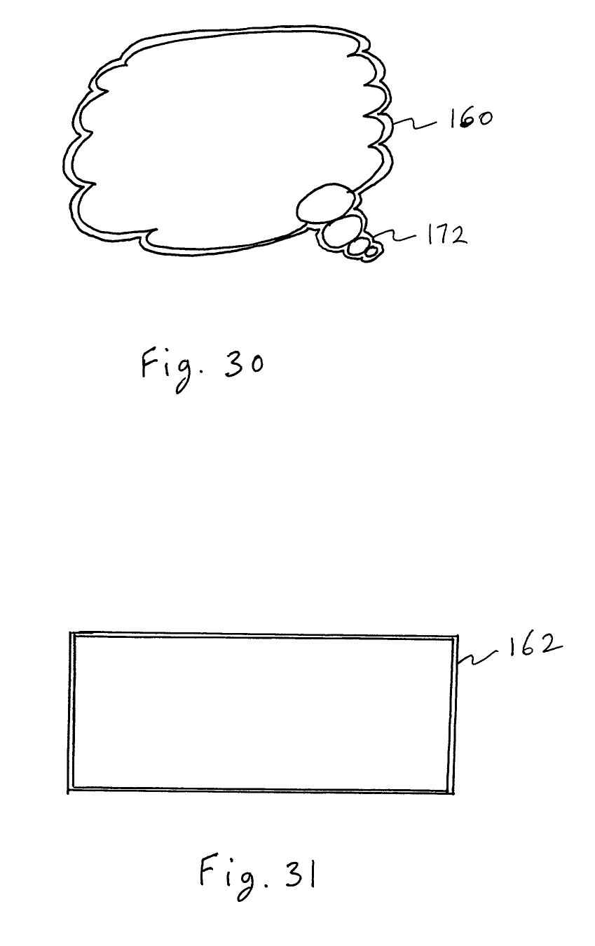

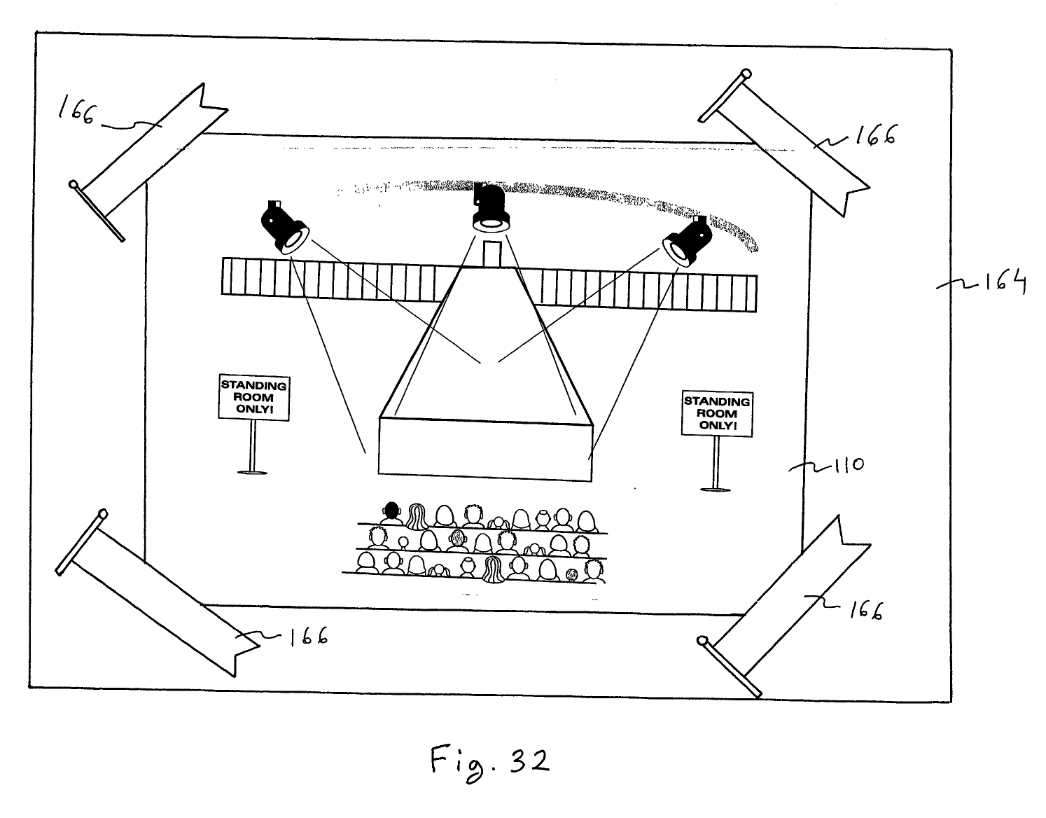

Referring to FIGS. 1-33, the present invention is directed to a magnetic coloring kit which serves as an activity game to entertain and keep occupied children between three to ten years of age. The magnetic coloring kit in its basic form includes at least a plurality of background sheets, e.g. 100, 102, 104, 106, 108, 110, and 112, and a plurality of magnetically attractive characters, for example, 114, 116, 118, 120, 122, 124, 126, 128,130, 132, 134, 136,138,140,142, 144,146, 148,150,152, 154, and 156. The term magnetically attractive as used herein includes both material that is itself a magnet and material that can be attracted by a magnet such as, for example, ferrous metals. The magnetically attractive characters 114-156 are preferably a set of cartoon characters. They may be constructed of a molded plastic base that is somewhat flattened or plate-like. One side of the base, the top side, would have the features of the character thereon, and the other side of the base, the bottom side, would be essentially flat and be magnetically attractive. The characters should be large enough in size so as not to form a choking hazard. The features of the character could be formed on the top side using any well known process. For example, the character features may be provided as a drawing on a sheet that is laminated or adhered to the top side of the character base. Alternatively, the features of the character may be drawn or painted on the top side of the character base. The features of the character may be also be provided in relief on the top side of the character base and then painted over.

The bottom side of the character base may have magnets embedded therein. Alternatively, a magnetic sheet may be laminated to the bottom of the character base. As yet another alternative, the character base itself may be a magnetic laminate or sheet having the depiction of the cartoon character laminated to the top side thereof in a manner similar to a refrigerator magnet. In plan view, the perimeter of the character base closely follows the outline of the depiction of the character on the top side of the character base such that the area of the background covered by the character is minimized.

The plurality of background sheets may include any combination of un-colored plastic background sheets having a preprinted outline similar to those shown in FIGS. 1-7, blank plastic background sheets, un-colored paper background sheets having a preprinted outline, and blank paper background sheets. In addition, some of the background sheets may be transparent while others may be opaque. The magnetically attractive characters are adapted for placement over the plurality of background sheets.

Additional items that may be included in the magnetic coloring kit include a plurality of magnetically attractive captions 158, 160, and 162, a plurality of markers (not shown), a magnetically attractive support surface 164, and corner support magnets 166.

The plurality of magnetically attractive captions 158, 160, and 162 are also adapted for placement on any of the background sheets and may constructed using any of the methods enumerated with respect to the magnetically attractive cartoon characters. The magnetically attractive captions 158, 160, and 162 may be of any of at least three types. One type 158 for carrying text indicative of speech attributable to a selected one of the plurality of magnetically attractive characters, one type 160 for carrying text indicative of thoughts attributable to a selected one of the plurality of magnetically attractive characters, and one type 162 to carry text indicative of descriptive material about a scene or visual composition.

The magnetically attractive captions 158 for conveying speech have a text portion 168 and a pointer portion 170. The text portion 168 is a substantially flat area of the caption suitable for carrying text. The text may be preprinted on the text portion of the caption or the text portion of the caption may be blank and adapted to allow a user to write text of their own selection on the text portion of the caption. The pointer portion 170 has a relatively pointed corner. The caption is placed on a background sheet in such a way that its pointer portion 170 points to the character, also positioned on the background sheet, to which the user intends to ascribe the speech carried on the text portion 168 of the caption.

The magnetically attractive captions for conveying thoughts 160 are essentially similar to the magnetically attractive captions for conveying speech except that they have pointer portions 172 that are shaped differently. The pointer portion 172 of the magnetically attractive captions for conveying thoughts are in the form of a series of adjacent bubbles or ovals that progressively decrease in size with increasing distance from the text portion. By positioning the caption such that the smallest oval is closest to a character, the text in the caption can be attributed to that character.

The magnetically attractive captions 162 for conveying descriptive matter have a text portion but lack a pointer portion. Otherwise the captions for conveying descriptive matter are similar to the other magnetically attractive captions described above.

In one embodiment, the text portions of the magnetically attractive captions can have a paper layer laminated on the top side thereof. The paper layer can have preprinted text or the paper layer can be blank so that users can write in their own selected text.

The plurality of markers are provided for coloring in or drawing on the background sheets. The markers included in the kit should be provided in a variety of colors to allow the user the flexibility to express himself or herself creatively. The user will thus be able to select the color of every portion of the background sheets and of every item appearing on the background sheet. Preferably, the markers are of a type that is washable when applied to the plastic background sheets in order to allow the plastic background sheets to be reused.

The magnetically attractive support surface 164 is preferably a ferrous metal sheet that defines a backboard to which the magnetic characters and captions will adhere through the magnetic attraction between the support surface and the magnets incorporated in the characters and captions. Alternatively, the support surface may be magnetic, such as by having a magnetic sheet laminated thereto or having magnetism induced therein by an electric field, and the characters and captions may have ferrous metal inserts which allow them to magnetically adhere to the support surface. The support surface 164 may be provided with a support means (not shown) such as a tripod, a stand, a hinged prop, an easel, or a means for hanging the support surface on a wall.

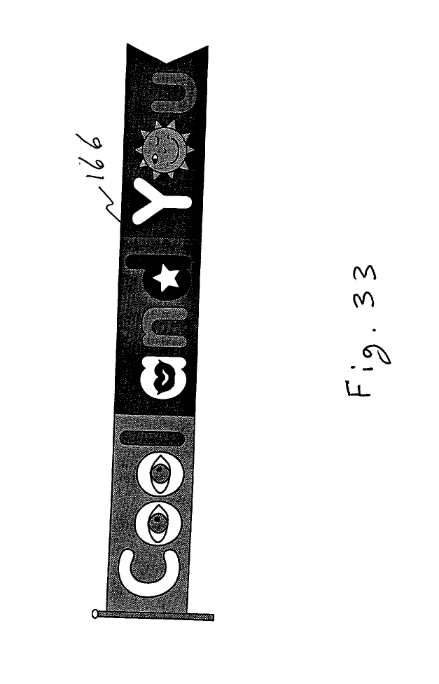

The corner support magnets 166 may be provided for holding the background sheets against the magnetically attractive support surface even as the magnetically attractive characters and captions are removed, are moved about on the background sheet, or are replaced by other magnetically attractive characters and captions. The corner support magnets 166 are intended for being placed over the comers of a background sheet that is being used to create or compose a scene or visual composition. The corner support magnet can bear colorful designs such as the banner logo displayed in FIG. 33.

In use, a child using the kit would use the markers to color in a preprinted outline or to draw a background scene of his or her own creation using one of the background sheets. Then the child can place the background sheet over the backboard and hold it in place using the corner magnets. The child can then place the magnetic characters and captions on the background sheet to create a visual composition. The magnetic attraction between the magnetically attractive characters and the magnetically attractive support surface helps retain the magnetically attractive characters in the locations selected by the user on the selected background sheets and helps reduce the likelihood of the characters being moved unintentionally when the magnetically attractive support surface is jostled or when the visual composition is displayed vertically. The visual composition can then be presented to grownups or friends, or the child may continue play by acting out a story line of his or her own creation, or a story line suggested in the kit, by moving the characters about the background scene and changing captions and characters. At this stage of play several may participate with each child assuming the role of their favorite character. As the story line moves from one scene to the next new background sheets can be colored in or created to replace the previous background sheet. A group of children can undertake to create a series of background sheets with each child assuming responsibility for creating one of the background scenes. The children can then get together to act out the story with each child manipulating his or her own character, and the children can go through a sequence of the background scenes they previously created as the story line moves along. Once play is over the paintings and color can be removed from the washable background sheets so that the background sheets can be reused.

The set of magnetic cartoon characters supplied with the kit may be selected such that various ethnic, cultural, and social groups are represented. Further, the characters supplied with the kit may be assigned various positive and desirable traits through the captions provided. Thus, during play the children learn tolerance for different groups in society and to value diversity. The child can also learn to associate various positive traits with the various social groups in society, thus helping to dispel negative stereotypes. In addition, as the child plays the role of a particular character, the positive trait associated with the character is instilled in the child. Also, if the child has basis to identify with the character, such as a common social group or social status, seeing the positive attributes of that character can improve the child's self esteem and give the child a more positive self image.

### Magnetic Coloring Kit Example

An example of a magnetic coloring kit made in accordance to the present invention is illustrated in FIGS. 1-33. Children ages three to ten years old can use the kit to color in the preprinted drawings 100-112 or draw their own. Then they can place the magnetic characters 114-156 and captions 158-162 on the drawings using the magnetic backboard or support surface 164. The refrigerator can also be used as a backboard.

The example kit comes in a 12 inch wide by 14 inch long by 2 ¼ inch high full color cardboard box (not shown) with the instructions for using the kit printed in black ink on the inside of the box top. The example kit contains one cardboard box (4 inch wide by 7 and ⅛ inch long by ⅞ inch high) for holding the markers, twenty eight cartoon character magnets (1 and ½ inch by ¾ inch over all), eight corner magnets 166 (¾ inch wide by 1 and ½ inch long) carrying the logo shown in FIG. 33, twenty eight caption magnets 158, 160, and 162(½ inch wide by 1 ½ inch long), four Write your-own (i.e. blank) caption magnets 158-162(1 ½ inch wide by 1 ½ inch long), one relatively thin magnetic backboard 164 (10 inch wide by 12 inch long by 3/16 of an inch high) for supporting the background sheets, seven plastic sheets (8 ½ inch by 11inch) each with a preprinted drawing outline printed thereon in permanent black ink, two blank washable sheets (8 ½ inch by 11 inch), and 9 washable markers (red, yellow, blue, green, purple, pink, orange, brown, black) each having a 5/8 inch radius and being 7 inches long.

The contents of the kit would be placed in the box from the bottom up in this order:

1. Blank plastic sheets;

2. Preprinted plastic sheets;

3. The magnetic backboard;

4. The magnetic characters, captions and corner magnets; and

5. The box of markers.

The user can make photocopies of the background sheets if needed. In use, an un-colored printed plastic background or a photocopy of an un-colored printed plastic background or a plain plastic background or a plain piece of paper is selected. The plastic or paper background sheet is placed on the magnetic backboard and held in place with 4 or more corner magnets. Only washable markers should be used on the plastic background sheets. Regular crayons, permanent markers, colored chalk, or pens and pencils can be used on the paper backgrounds supplied or generated by photocopying. When the user is finished coloring in the plastic or paper background sheet, the user can place the magnetically attractive cartoon characters where they wish on the background sheet. The caption magnets can be placed proximate the characters in any desired combination. The user can also create their own captions by writing user selected text on the blank caption magnets. The user can then place the background sheet on the magnetically attractive backboard and secure the background sheet in place using the comer magnets. Then the user can place the character magnets at any desired location on the background sheet. Optionally, the user can hang the background sheet up on a refrigerator using the corner magnets. Next, the user can select the captions that will be used with the chosen magnetic characters and the user may write their own selected text on the blank caption magnets. The user can then color in a fresh background sheet and repeat the steps outlined above to create new visual compositions.

It should be noted that the present invention is not limited to the illustrative embodiments described above, but includes any and all embodiments within the spirit and scope of the appended claims.

I claim:

1. A magnetic coloring kit comprising:
a plurality of background sheets; and
a plurality of magnetically attractive characters adapted for placement over said plurality of background sheets,
whereby when a selected one of said plurality of background sheets is placed over a magnetically attractive support surface, at least a selected one of said plurality of magnetically attractive characters can be placed by a user on said selected one of said plurality of background sheets in order to compose a scene and such that magnetic attraction between said selected one of said plurality of magnetically attractive characters and said magnetically attractive support surface helps retain said selected one of said plurality of magnetically attractive characters in a location on said selected one of said plurality of background sheets selected by the user.

2. The magnetic coloring kit according to claim 1, further comprising a plurality of magnetically attractive captions each adapted for placement on any of said plurality of background sheets and each adapted to carry text indicative of one of speech attributable to a selected one of said plurality of magnetically attractive characters that is being used to compose a scene, thoughts attributable to a selected one of said plurality of magnetically attractive characters that is being used to compose a scene, descriptive material about a scene being composed, and any combination thereof.

3. The magnetic coloring kit according to claim 2, wherein a selected number of said plurality of background sheets are washable sheets.

4. The magnetic coloring kit according to claim 3, wherein a selected number of said washable sheets are transparent sheets.

5. The magnetic coloring kit according to claim 4, wherein a selected number of said transparent sheets are provided with preprinted outlines adapted to be colored in by a user.

6. The magnetic coloring kit according to claim 5, further comprising:
a plurality of markers of a variety of colors adapted to be used to color said plurality of background sheets, and said markers being adapted such that any marks made by said markers are removable when the marks are made on one of said plurality of background sheets that is a washable sheet.

7. The magnetic coloring kit according to claim 6, wherein a selected number of said plurality of background sheets are opaque sheets.

8. The magnetic coloring kit according to claim 7, wherein a selected number of said plurality of background sheets are blank sheets such that a user can freely create a background of their own design.

9. A magnetic coloring kit comprising:
a plurality of background sheets;
a plurality of magnetically attractive characters adapted for placement over said plurality of background sheets;
a plurality of magnetically attractive captions adapted for placement on any of said plurality of background sheets and for conveying one of speech attributable to a selected one of said plurality of magnetically attractive characters that is being used to compose a scene, thoughts attributable to a selected one of said plurality of magnetically attractive characters that is being used to compose a scene, descriptive material about a scene being composed, and any combination thereof;
a plurality of markers of a variety of colors adapted to be used to color said plurality of background sheets; and
a magnetically attractive support surface,
whereby,
a user can create a background scenery on a selected one of said plurality of background sheets,
when a selected one of said plurality of background sheets is placed over said magnetically attractive support surface, at least a selected one of said plurality of magnetically attractive characters can be placed by a user on said selected one of said plurality of background sheets in order to compose a scene, and
magnetic attraction between said selected one of said plurality of magnetically attractive characters and said magnetically attractive support surface helps retain said selected one of said plurality of magnetically attractive characters in a location selected by the user on said selected one of said plurality of background sheets.

10. The magnetic coloring kit according to claim 9, wherein a selected number of said plurality of background sheets are washable sheets.

11. The magnetic coloring kit according to claim 10, wherein a selected number of said washable sheets are transparent sheets.

12. The magnetic coloring kit according to claim 11, wherein a selected number of said transparent sheets are provided with preprinted outlines adapted to be colored in by a user.

13. The magnetic coloring kit according to claim 12, wherein said plurality of is markers are further adapted such that any marks made by said markers are removable when the marks are made on one of said plurality of background sheets that is a washable sheet.

14. The magnetic coloring kit according to claim 13, wherein a selected number of said plurality of background sheets are opaque sheets.

15. The magnetic coloring kit according to claim 14, wherein a selected number of said plurality of background sheets are blank sheets such that a user can freely create a background of their own design.

16. A method of playing a coloring and activity game, the method comprising the steps of:
creating background scenery on a background sheet;
placing the background sheet having the background scenery on a magnetically attractive support surface; and
placing at least one magnetically attractive character on the background sheet having the background scenery thereon such that magnetic attraction between the magnetically attractive character and the magnetically attractive support surface helps retain the magnetically attractive character in a location selected by the user on the background sheets to thereby compose a scene.

17. The method of playing a coloring and activity game according to claim 16, further comprising the step of:
placing at least one magnetically attractive caption containing text indicative of one of speech attributable to the magnetically attractive character that is being used to compose a scene, thoughts attributable to the magnetically attractive character that is being used to compose a scene, descriptive material about the scene being composed, and any combination thereof.

18. The method of playing a coloring and activity game according to claim 17, wherein said step of creating background scenery comprising the step of:
coloring in a preprinted outline provided on the background sheet.

19. The method of playing a coloring and activity game according to claim 18, wherein said step of creating background scenery comprising the step of:
drawing a background scene of a users own design on the background sheet.

20. The method of playing a coloring and activity game according to claim 19, wherein the magnetically attractive caption is initially blank, the method of playing a coloring and activity game further comprising the step of:
writing text selected by the user and indicative of one of speech attributable to the magnetically attractive character that is being used to compose a scene, thoughts attributable to the magnetically attractive character that is being used to compose a scene, descriptive material about the scene being composed, and any combination thereof, on the magnetically attractive caption.
